(19) United States
(12) Patent Application Publication
(10) Pub. No.: US 2010/0107195 A1
(43) Pub. Date: Apr. 29, 2010

(54) Program preference setting method and system for a broadcasting video program

(76) Inventors: Ming-Jen Hsu, Taipei City (TW); Shih-Chang Chen, Sinfong Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/320,223

(22) Filed: Jan. 22, 2009

(30) Foreign Application Priority Data
Oct. 24, 2008 (TW) 97140827

(51) Int. Cl. H04N 5/445; G06F 3/00

(52) U.S. Cl. 725/44; 715/719

(57) ABSTRACT

A program preference setting method and system for broadcasting video program are disclosed. The preference setting method and system are generally applied to an Electronic Program Guide (EPG) for the digital television program. More particularly, a program preference setting system is provided to be embedded in the digital broadcast program receiving and playing device. One or more keywords may be set to the electronic program guide. Through comparison between the keyword(s) and the content of EPG, the positive comparison result is found for scheduling a program sequence. Further, a reminder corresponding to the program sequence may be set in a certain period through the system, and shown on the screen for user's convenience.

### BACKGROUND OF THE INVENTION

1. Field of the Invention

The present invention relates to a program preference setting method and the system, more particularly, a user's preference for the TV programs is set by comparing keyword to an electronic program guide.

2. Description of Related Art

When users watch television programs, they generally use a remote control to switch the programs in sequence, or to select the program desired to be watched in accordance with a recent schedule the TV broadcast company provides. However, those ways are not efficient relating to scan the programs.

An analog television broadcast system, such as a cable TV that broadcasts analog signals or the wireless broadcast system that broadcasts signals over the air, broadcasts the signals without carrying any information concerning the TV station's program schedule. The users always need to scan the program based on their memory, newspaper's report, or the program notice.

Otherwise, if the TV broadcast system broadcasts the digital signals, a digital audio/video converter may be utilized to receive the broadcast signals. A set-top-box (STP) is usually to be utilized in which to convert the received compressed signals into the TV program content. After that, the content is displayed on the television. The signals may be transmitted via a cable, a satellite antenna, a wideband network and a terrestrial broadcasting. In particular, the content received by the set-top-box not only includes video and audio, but also receive the signal data, that is an electronic program guide (EPG).

The mentioned electronic program guide is digital-type information, and is implemented as an interactive menu shown on a TV screen. Users may scan the program information provided by the TV station through the electronic program guide, or through its interactive menu. The program information probably includes the current or recent program schedule having titles, brief introductions, channel numbers, program types and the like. Users can use the remote control, keyboard or other input tools to make a selection of the programs.

Reference is made to FIG. 1 shows a schematic diagram of the conventional electronic program guide. Users may use the remote control 12 to enter an electronic program guide, which is such as the content shown on the television screen 10. The content at least includes a channel selection 101 which users may use the remote control 12 to make a selection having introduction to the TV channel to be watched. The part on the left side shows the program titles 102, including program 1, program 2, program 3, program 4, program 5 and program 6. The Up key and Down key are used for switching between programs, and the part on the right side of the screen shows the program introductions 103 corresponding to the selection on the left side.

### SUMMARY OF THE INVENTION

It's to take advantage of the electronic program guide (EPG) sent from a digital broadcast program, one of the objects of the present invention is to provide a program preference setting method and system for broadcasting video program. In which, users may input one or more keywords in the program preference setting system through an interactive electronic program setting interface. After comparing the keyword(s) with the content of the electronic program guide, users may conveniently obtain the preferred program guides, or even a relevant reminder can be shown on the television screen at a determined time.

According to the preferred embodiment of the program preference setting method of the present invention, a program preference setting system is entered at the first step. Next, an electronic program guide is updated and received through a remote connection. Users may input one or more keywords by utilizing a control device as entering a related setting page. After the program preference setting system receives the inputted keyword(s), the keywords are used to compare with the content of the electronic program guide, so as to select one or more matched programs. After that, a program schedule is configured.

After the program schedule is obtained, the system provides some applications, such as to set a reminder, so the reminder with the programs approaching the corresponding keywords reminder can be shown in a certain period. Users can watch the preferred programs more efficiently. Furthermore, users may switch the programs in sequence but ignore the programs without matching any keyword.

The claimed system is applied to a digital broadcast program receiving and playing device, and this system is implemented as software that provides an interactive electronic program setting interface to interact with the users. One of the embodiments of the claimed system includes a means for retrieving an electronic program guide, that is used to retrieve or update the electronic program guide transmitted from the broadcast television station. A means for inputting keyword(s) is further included to receive the keyword(s) inputted by the users using a remote control device. Next, a means for comparing is used to compare the keyword(s) with the content of the electronic program guide. Furthermore, a scanning means is to scan the channels with corresponding keyword(s). After a positive comparison result produces, the matched channel may be displayed on a screen in certain period as broadcasting a program by a displaying means.

Therefore, by means of comparing keywords, the program preference setting method and system for broadcasting video program are provided to scan the preferred programs more efficiently.

### BRIEF DESCRIPTION OF THE DRAWINGS

The present invention will be readily understood by the following detailed description in conjunction accompanying drawings, in which:

FIG. 1 shows a schematic diagram of an electronic program guide of the prior art;

FIG. 2 shows one of the schematic diagram of a setting page of the program preference setting method of the invention;

FIG. 3 shows another schematic diagram of a setting page of the program preference setting method of the invention;

FIG. 4 shows one more schematic diagram of a setting page of the program preference setting method of the invention;

FIG. 5 shows a schematic diagram of a reminder generated after setting the program preference;

FIG. 6 is a block diagram of the program preference setting system of the present invention;

FIG. 7 is a flow chart of the program preference setting method of the present invention;

FIG. 8 shows a flow chart of displaying a program reminder made by the program preference setting method of invention.

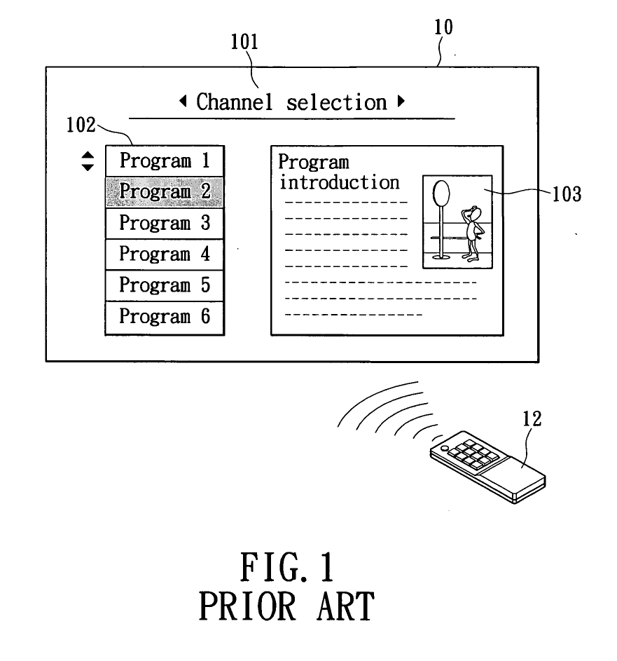

### DETAILED DESCRIPTION OF PREFERRED EMBODIMENTS

For further understanding of the invention, please refer to the following detailed description illustrating the embodiments and examples of the invention. The description is only for illustrating the invention and is not intended to be considered limiting the scope of the claim.

The present invention relates to a program preference setting method and a system for broadcasting video program. An interactive setting page of the system is provided for users inputting the keywords relating to some specific programs. The TV program preference is set through a comparison between an electronic program guide (EPG) and the user's inputted keywords. Other than the analog broadcast signals, the electronic program guide is accompanied with the broadcasting digital TV program. Thus the user may get the preferred programs easily after processing the comparison between the keywords and the EPG, and then a program reminder is provided to be shown on the TV screen.

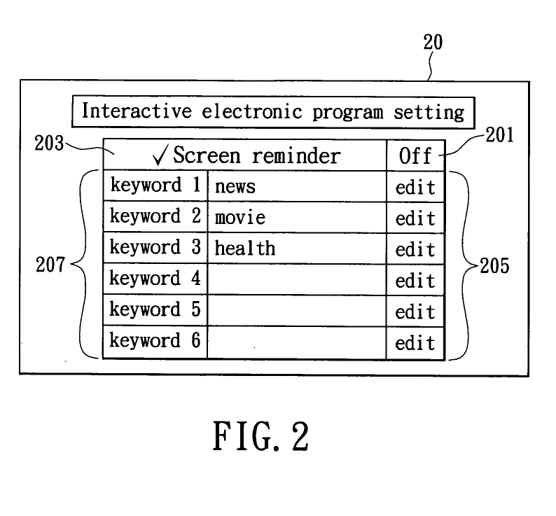

According to the preferred embodiment, the program preference setting method performs a configuration and inputting keywords through a setting page shown as the schematic diagram of FIG. 2. Further, the claimed system for broadcasting video program displays an interactive electronic program setting interface shown on the TV screen 20. In which, the interactive electronic program setting interface has a region 203 for configuring a on-screen reminder, a button 201 for configuring an activation or de-activation of keyword function, a region 207 for inputting keyword, and a button 205 for editing multiple keywords.

In a preferred embodiment, the system for setting program preference is implemented preferably by software coded in the digital broadcast program receiving and playing device or a series of firmware programs. The user may use a control device (such as remote control) to enter the setting page as broadcasting the digital program.

The interactive electronic program setting interface shown on the TV screen 20 provides a keyword input region 207 having a plurality of input fields. Therein, the user uses the control device to input one or more keywords. By comparing the content of electronic program guide with the inputted keyword(s), the user-preferred programs may be retrieved consequently. Further, a reminder including the preferred program notice is functioned as shown on the TV screen in a certain period.

For example, the keywords such as the “news”, “movie”, and “health” are shown on the diagram, and the edit button 205 is provided for new adding, modifying or deleting the keyword(s). According to this exemplary example, the user may choose to watch the programs fit in with those keywords having “news”, “movie” or “health”. The claimed system will compare those keywords with the received electronic program guide, and filter off the not-matched programs. At the moment, the user may utilize the button 201 to activate or de-activate the keyword function. The user merely browses the broadcast programs fit in with those keywords since the keyword function is activated.

In this preferred embodiment, the claimed program preference setting system provides a reminder function in real time. An interactive electronic program setting interface is further functioned to provide a region 203 for setting a reminder on the screen. The user may check this region 203 to decide whether or not to function the reminder. Once the reminder is set, in accordance with the keyword(s), the reminder, which includes the program notice with the recently-matched programs or the programs matched over a time span, will be shown on a specific position of the screen.

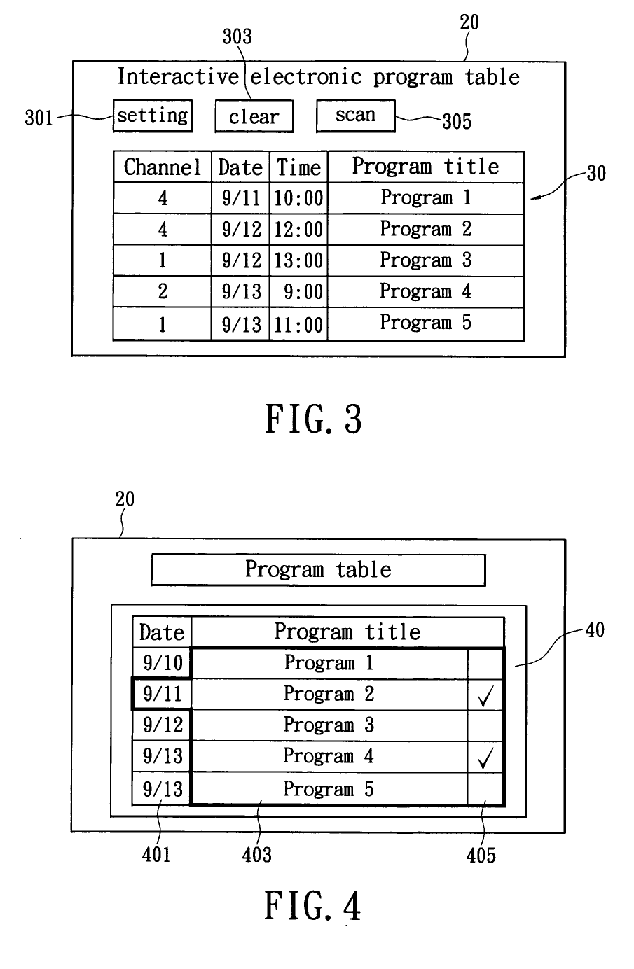

Next, FIG. 3 shows a schematic diagram of a setting page applied to the claimed program preference setting method. A preferred program schedule 30 after a keyword comparison, and a plurality of software buttons are shown on a screen 20. Preferably, they are a setting button 301, a clear button 303, and a scan button 305.

The setting page shown in the FIG. 3 is an interactive electronic program table. Through the comparison with the keyword(s), the comparison result including a plurality of recent program channels, dates, times and the titles is shown on the preferred program schedule 30. The user may execute many kinds of settings through the mentioned setting button 301, clear button 303, and scan button 305. The setting button 301 is utilized to go to a keyword setting page (shown as FIG. 2), and to execute editing or deleting. The clear button 303 is utilized to clear the result of the preferred program schedule 30. The scan button 305 is utilized to refresh the comparison, and find a new result. After scanning the programs, a plurality of TV programs, including program 1, program 2, program 3, program 4 and program 5, are shown.

The above-mentioned comparison result is the source for processing a screen reminder. Reference is made to FIG. 4 showing a setting page applied to the claimed method. A keyword-matched program schedule 40 capable of setting reminder is shown on the screen 20. This program schedule 40 at least has three regions, such as a date region 401, a program title region 403, and a selection region 405.

The date region 401 shows a latest date of the recently retrieved electronic program guide. After a selection, the program title region 403 shows the program title in accordance with the keyword(s) at a certain date. The side bar of the program title region 403 has a selection region 405 with a plurality of checks. The user may set the one or more programs in need of reminding through the selection region 405. In this exemplary example, the program titles such as program 1, program 2, program 3, program 4 and program 5 in accordance with some certain keywords are shown at September 11. After this selection, the selection region 405 shows that the user selects program 2 and program 4 to be reminded.

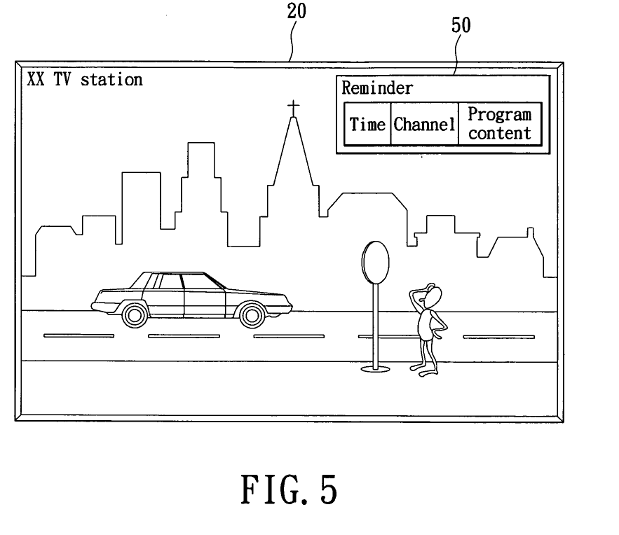

Reference is made to FIG. 5, when a user watches a TV program, a reminder 50 in accordance with the program preference setting is shown on a specific position of the screen 20. The reminder 50 includes a selected program time, channel and the brief content. The user may refer to the next interested program, or recent matched program notice in real time.

The reminded program content corresponds with the comparison result by keyword(s). Then the user selects the program(s) to be reminded. Importantly, the electronic program guide of the setting system should be kept latest and accurate by updating in a preferred embodiment. Therefore, a reliable screen reminder can be provided after comparing the keyword(s) and scanning the result. The timing for updating the electronic program guide can be the occasion as the user switching the programs. The alternative timing for update the EPG can be the occasion of shutting down the digital broadcast program receiving and playing device, or the occasion of booting up this device. A further timing for updating the EPG can be the time as the user utilizing a software button to execute the updating.

In order to perform the program preference setting applied to the digital broadcast program receiving and playing device, the preferred embodiment of the present invention is to install the claimed program preference setting system in the device. Further, the installed system is implemented as software or a series of firmware program. Thereby, the user uses the functions through the interactive electronic program setting interface.

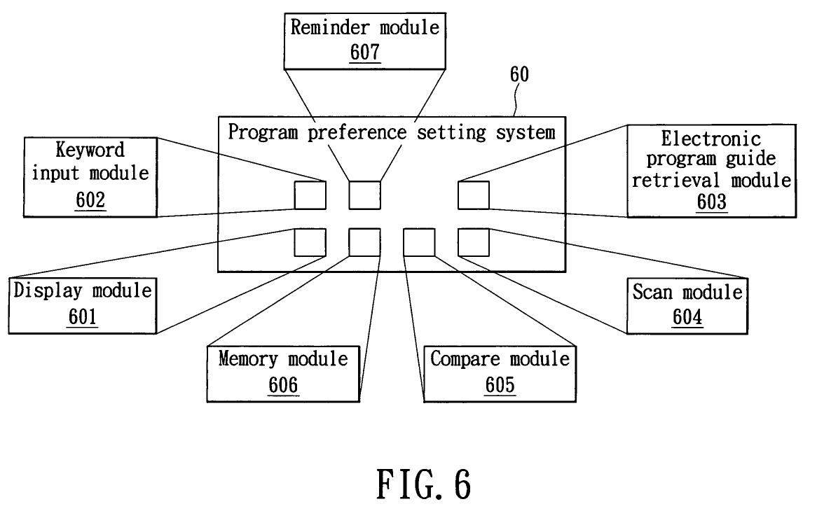

One embodiment of the program preference setting system is shown in FIG. 6. The program preference setting system 60 includes the software or firmware-implemented display module 601, keyword input module 602, electronic program guide retrieval module 603, scan module 604, compare module 605, memory module 606, and a reminder module 607.

The program preference setting system 60 retrieves or updates the electronic program guide transmitted from each broadcast television station by the electronic program guide retrieval module 603. The timing for retrieving or updating has been described above. The timing can be the occasion of shutting down the digital broadcast program receiving and playing device, in the meantime, the system connects to every broadcast television station for updating the EPG. Alternatively, the EPG can be updated as the user utilizing a control device to switch the program, or actively utilizing a button to perform the updating process.

The keyword input module 602 of the program preference setting system 60 receives the keyword(s) inputted by the user utilizing the control device through an input interface, such as the specific fields in the interactive electronic program setting interface. After the keyword input module 602 receives the keyword(s), the compare module 605 is next used to perform a comparison process for comparing the content of the EPG and the keyword(s). The comparison result is transferred to the scan module 604 for scanning the channels according to the positive comparison result. The drawings with inputting keyword(s), scanning, and the like are displayed on the screen to the user by the display module 601, and the interactive electronic program setting interface is provided to be interacted with the user.

Further, the program preference setting system 60 has a reminder module 607, which is used to set a screen reminder through the interactive interface. The user may use the function of the reminder module 607 to select one or more programs to be reminded. In a certain period, the reminder is displayed on the screen as broadcasting the digital program. The displayed content includes recent matched program notice, or the program matched over a time span. The reminder module 607 further provides the ways to remind, such as the position, time, time-interval, or the content order to be displayed on the screen.

In addition to the above-mentioned software modules, the program preference setting system 60 further needs a memory module 606 to buffer the date of the digital broadcast program receiving and playing device. The data stored in the memory preferably includes the electronic program guide, the keywords, and the channel information in accordance with the positive comparison result. Then the program preference setting system 60 displays the information according to the stored data.

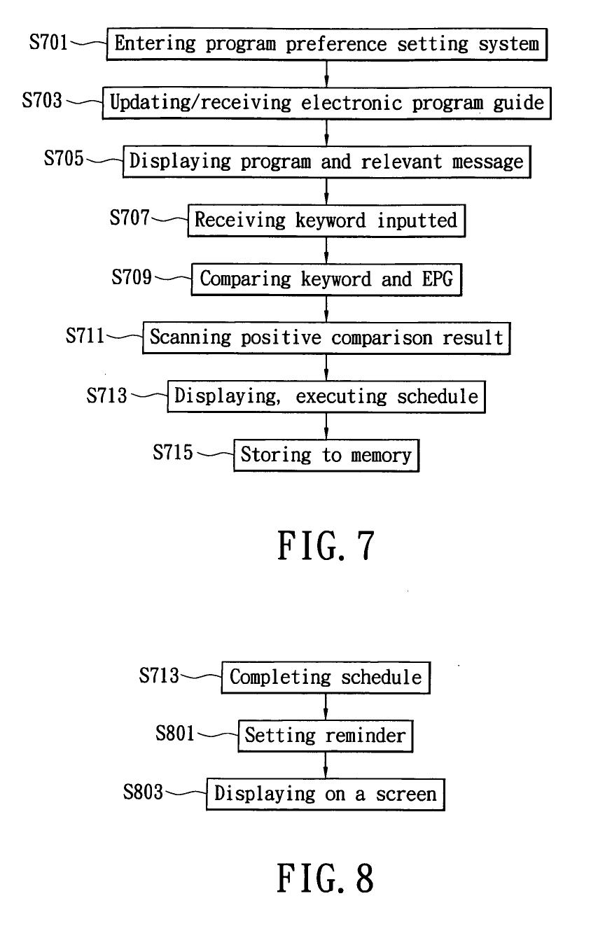

Reference is made to FIG. 7 illustrating a flow chart of the embodiment of the claimed program preference setting method.

In the beginning as step S701, a user may utilize a remote controller or other control device to enter a program preference setting system of a digital broadcast program receiving and playing device, such as a set-top-box (STB). At the moment, a program schedule and the relevant time are displayed for user's selection. The system updates or receives a electronic program guide as booting up the digital broadcast program receiving and playing device, or on the above-mentioned occasions. In the preferred embodiment, the electronic program guide retrieval module 603 is used to perform the updating process (step S703).

Next, the display module is used to display the latest electronic program guide and the relevant message on the screen, including the time and the programs associated with each channel (step S705).

At the moment as entering a setting page, an interactive electronic program setting interface is launched. The user inputs keyword(s), and the system receives the keyword(s) by the keyword input module (step S707).

The received electronic program guide and the keyword(s) are stored in a memory. The compare module is further used to compare the stored keyword(s) and the content of the electronic program guide. The textual information, such as program title and its introduction, transmitted from the digital broadcast stations is used to compare with the keyword(s) (step S709). After that, the system scans the positive comparison result accordingly (step S711).

In next step S713, the program preference setting system schedules the filtered programs, and displays the user-preferred programs in accordance with the keyword(s) on the screen. After scheduling, some applications may be functioned, such as setting reminder for displaying the reminder for the corresponded programs in a certain time, then the user may select the preferred programs more efficiently, or the not-matched programs can be ignored as the user switches the programs in sequence.

At last, those schedules, keywords, reminder, particularly the EPG are stored in a memory (step S715). At some specific occasions, the EPG will be updated and compared with the keyword(s) automatically for assuring the accuracy of the EPG and the preferred content.

After scanning the preferred programs, the screen reminder can be functioned accordingly. Reference is made to FIG. 8 showing the steps of displaying the reminder.

Since the program schedule is finished (step S713), a reminder setting is further in progress (step S801). The user may set a screen reminder according to the program schedule made by the program preference setting system. The user may selects the programs to be reminded by checking. The reminder module of the program preference setting system displays the reminder on the screen in a certain period based on the setting as broadcasting the digital programs (step S803). FIG. 5 shows an example for reminding.

In summation of the description, the present invention provides a program preference setting method the system using the same, and the system is applied to a digital broadcast program receiving and playing device. In which, according to user's inputted keyword(s), the preferred program may be obtained by comparing with the content of EPG. Moreover, a reminder can bring a convenient effect.

The many features and advantages of the present invention are apparent from the written description above and it is intended by the appended claims to cover all. Furthermore, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. A program preference setting method, which is applied to a digital broadcast program receiving and playing device, comprising:
entering a program preference setting system;
receiving the content of an electronic program guide and updating the content of the electronic program guide;
receiving one or more keywords inputted;
comparing the keyword with the content of the electronic program guide;
scanning one or more programs in accordance with a positive comparison result; and
scheduling a program sequence.

2. The method of claim 1, further comprising a step of displaying a current program schedule and its relevant time for user's selection after entering the program preference setting system.

3. The method of claim 1, further comprising a step of displaying the positive comparison result on the digital broadcast program receiving and playing device after the step of scanning the programs.

4. The method of claim 1, further comprising a step of setting a reminder after scheduling the program sequence.

5. The method of claim 4, wherein the reminder is displayed according to the setting as the digital broadcast program receiving and playing device broadcasts program.

6. The method of claim 1, wherein the keyword is used for making a comparison to a program title of the electronic program guide and the program's introduction.

7. The method of claim 1, wherein a user inputs the keyword through an interactive electronic program setting interface.

8. The method of claim 1, wherein the update timing for the electronic program guide includes one of the following conditions:
an occasion of turning off the digital broadcast program receiving and playing device;
an occasion of turning on the digital broadcast program receiving and playing device;
an occasion of switching the program; and
an occasion of a user uses a software button to execute a updating of the electronic program guide.

9. A program preference setting system applied to a digital broadcast program receiving and playing device, comprising:
means for retrieving an electronic program guide, retrieving or updating the electronic program guide from each broadcast television station;
means for inputting keyword, receiving the keyword inputted to an input interface by a user through a control device;
means for comparing, comparing the keyword with the content of the electronic program guide;
means for scanning, scanning one or more corresponding channels in accordance with a comparison result;
means for reminding, receiving a reminder set by the user, and displaying the reminder on a screen as broadcasting a digital broadcast program; and
means for displaying, displaying a positive comparison result after scanning.

10. The system of claim 9, further comprising a means for memorizing, which is used for storing the data of the digital broadcast program receiving and playing device.

11. The system of claim 10, wherein the memorizing means stores the electronic program guide via a memory.

12. The system of claim 10, wherein the memorizing means stores the corresponding channel information using a memory after comparison.

13. The system of claim 12, wherein the system displays the channel information in accordance with the comparison result stored by the memorizing means.

14. The system of claim 9, wherein the electronic program guide is updated at a certain occasion.

15. The system of claim 14, wherein the occasion to update the electronic program guide includes:
an occasion of turning off the digital broadcast program receiving and playing device;
an occasion of turning on the digital broadcast program receiving and playing device;
a occasion of switching the program; and
an occasion of the user uses a software button to execute a updating of the electronic program guide.

16. The system of claim 9, wherein the means for inputting keyword provides the user to input one or more keywords.

17. The system of claim 16, wherein the user inputs the keyword through an interactive electronic program setting interface.

18. The system of claim 9, wherein the means for reminding is used to turn the reminder on, and display a program notice with corresponding keyword on the screen in a recent period or at a certain time.

19. The system of claim 18, wherein the user utilizes the means for reminding to select one or more programs to be reminded.
